(19) United States
(12) Patent Application Publication
(10) Pub. No.: US 2010/0315021 A1
(43) Pub. Date: Dec. 16, 2010

(54) CIRCUIT AND METHOD FOR CONTROLLING RGB LED COLOR BALANCE USING A VARIABLE BOOSTED SUPPLY VOLTAGE

(75) Inventors: Francis Lau, Fremont, CA (US); John R. Haggis, San Jose, CA (US)

Correspondence Address: STAINBROOK & STAINBROOK, LLP, 412 AVIATION BOULEVARD, SUITE H, SANTA ROSA, CA, 95403, US

(73) Assignee: AERIELLE TECHNOLOGIES, INC., Fremont, CA (US)

(21) Appl. No.: 12/814,416

(22) Filed: Jun. 11, 2010

Related U.S. Application Data
(60) Provisional application No. 61/186,131, filed on Jun. 11, 2009.

(51) Int. Cl. H05B 37/02

(52) U.S. Cl. 315/294

(57) ABSTRACT

A microprocessor uses one or more output pins to pulse width modulate a charge pump network to achieve a boosted voltage on an output port. The boosted voltage is then used to drive an LED, which may have a higher voltage drop than that of the starting un-boosted voltage. The adjustment of either the frequency or duty cycle of the PWM signal allows for adjustment of the steady state output voltage. This allows for the adjustment of the brightness of the LED by firmware while supplying enough voltage drop required by the LEDs.

### CROSS REFERENCES TO RELATED APPLICATIONS

The present invention claims the benefit of U.S. Provisional Patent Application Ser. No. 61/186,131, filed (Jun. 11, 2009).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to a method for driving LEDs, and more specifically to a low-cost circuit and method for driving an RGB LED with color balancing capabilities.

2. Discussion of Related Art Including Information Disclosed under 37 CFR §§1.97, 1.98

The advent of using multi-color, red-green-blue (or “RGB”) LEDs in consumer electronics created an increasing need for a cost effective method of driving such lighting devices. At present the lithium ion battery is typically used to power LEDs in such devices, and it is down-regulated to a specified system voltage; usually 3.3V or lower. This voltage may then be the highest voltage employed in the system unless a boost regulator is used.

Typically, the red LED of the RGB LED assembly may be driven directly by a microprocessor running at 3.3V. However, the green and blue LEDs may require a higher voltage than 3.3V; otherwise, they may fail to illuminate. Hence, there is an immediate need to boost voltage to a sufficient level.

A typical solution to this problem is to use an external boost regulator to boost the system voltage to approximately 5V, which is more than sufficient to drive a green or blue LED. However, adding a boost regulator for this single purpose adds substantially to the costs of materials for low-cost consumer electronics products. Additionally, a boost regulator commonly involves an active part and a large inductor, and use of large components is generally undesirable because of the market trend toward smaller and cheaper consumer electronic goods.

There exist various methods of lighting an RGB LED, such as the method described in Mueller, et al. U.S. Pat. No. 6,150,774, in which each of the colors of an LED are digitally controlled and pulse-width-modulated (PWM) to control the brightness of each color. This method is a direct drive method in which the LED is pulse-width-modulated to achieve a higher or lower intensity of each color.

### BRIEF SUMMARY OF THE INVENTION

There is disclosed herein a circuit and method for boosting voltage using a pulse width modulated signal to drive a charge pump network. The boosted voltage is then used in various novel ways to drive the RGB LED assembly. This method allows for adjustment of each color in an RGB LED to achieve the proper color balance. Hence, any color desired may be displayed with this method. Unlike the method shown in Mueller et al (discussed above), the method described herein uses a steady current flow through the LED by adjustment of the driving voltage via an output capacitor. A constant flowing current may also extend the life of the LED by reducing the stress imposed on the LED from a pulsed input.

Abbreviations Used Herein: “PWM” means pulse width modulation; “RGB” means red-green-blue; “LED” means light emitting diode; and “MCU” means a microprocessor.

It is principal advantage of the present invention to remove the need of costly boost regulators by replacing such regulators with two Schottky diodes and two small ceramic capacitors for each LED to be driven. These added components form a charge pump network.

It is another advantage of the present invention to provide a circuit able to vary the drive to a corresponding LED by adjusting the frequency or duty cycle of the pulse width modulated signal.

It is yet another advantage of the present invention to gang three of above-referenced networks together and to properly control the intensity of each LED, thereby controlling the color balance.

It is still another advantage of the present invention to increase the drive current available in an LED-containing consumer electronic device by using additional output pins in the MCU to drive the PWM signal.

Still another advantage of the present invention is that it reduces ripple in the output node by feeding the output node with a second charge pump controlled by a PWM signal inverted in relation to of the signal from a first charge pump.

In an exemplary embodiment of the present invention, a microprocessor drives the charge pump of each LED with two output pins. A first output pin serves only to turn on and off the power to the charge pump, while a second output pin output serves as a signal and power source to the switched capacitor network. The pulsing of the second output pin allows for a boosted voltage at the output capacitor. The boosted voltage is maintained by the capacitance at the output node of the charge pump.

In order to maintain sufficient voltage, it is necessary to correctly adjust the frequency and duty cycle of the PWM signal driven to the input of the charge pump and to use the proper sizes for the switched capacitors.

The intensity range of the LED can then be adjusted by fine tuning the relationship between the PWM frequency driven to the input of the charge pump, the PWM duty cycle driven to the input of the charge pump, the capacitor sizes of the charge pump, and the proper resistor in line with the LED. With these adjustments made to yield the best intensity range, one can then make relatively fine adjustments to the intensity of the LED attached. With each of the RGB LEDs attached to a similar charge pump network (as shown in FIG. 1), relative intensities can be adjusted to obtain the proper color balance.

In practice, varying the frequency and/or duty cycle of the PWM signal does not yield a linear relationship to the intensity. Rather, the usable range of the variation is limited by the resolution of the frequency generator in the PWM signal driving the charge pump. Unless a high resolution PWM is used to drive the charge pump, the number of brightness levels obtained will be limited.

However, the present invention is well-suited for use in low cost electronic products. Therefore, the limited control of the brightness is more than sufficient to produce a particular hue using an RGB LED. The RGB LED driven by the inventive circuit can thus be used in color indication and anywhere else an LED may be needed.

Although the preferred embodiments of this invention contain charge pumps comprising Schottky diodes and capacitors, this invention does not exclude other embodiments which use alternative charge-pump implementations.

The foregoing summary broadly sets out the more important features of the present invention. It is to be understood that the disclosure is not limited in its application to the details of the construction and the arrangements set forth in the following description or illustrated in the drawings. The inventive circuit and method described herein is capable of other embodiments and of being practiced and carried out in various ways.

Other novel features characteristic of the invention, as to circuit device organization and its method of operation, together with further objects and advantages thereof will be better understood from the following description considered in connection with the accompanying drawings, in which preferred embodiments of the invention are illustrated by way of example.

### BRIEF DESCRIPTION OF THE SEVERAL VIEWS OF THE DRAWINGS

An understanding of the present invention is facilitated by a consideration of the following detailed description of the preferred embodiments of the present invention taken in conjunction with the accompanying drawings, in which:

FIG. 1 is a schematic circuit diagram showing three separate PWM outputs of a microprocessor driving three separate charge pump networks. Each network boosts the voltage and are used to drive the RGB LED.

FIG. 2 is similar to the schematic diagram of FIG. 1, but shows multiple microprocessor output pins driving the PWM input, thereby adding to current capability.

FIG. 3 is a schematic circuit diagram showing a drive configuration in which a complimentary PWM waveform supplies current to an output capacitor during the off phase of the primary PWM waveform using a separate charge pump branch.

### DETAILED DESCRIPTION OF THE INVENTION

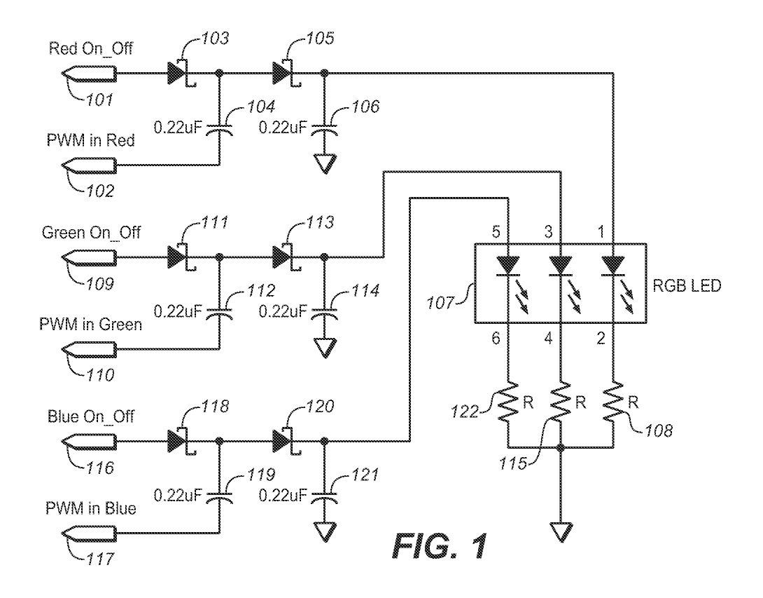

Referring first to FIG. 1, this schematic diagram shows how the interface of a microprocessor may be used to drive the RGB LED array using three separate charge pumps. The microprocessor drives pins 101 and 102 in order to achieve the boosted voltage across capacitor 106.

In operation, if the red LED is to be in the OFF mode, the MCU can drive pin 101 low while shutting off the PWM drive to pin 102. When the LED is desired to be in the ON mode, the MCU can drive pin 101 high and hence supply the current necessary to charge flying capacitor 104 when pin 102 is driven low.

Thereafter, the MCU will raise the PWM pin from low to high on one cycle of pulsing on pin 102. The high voltage at the low side of charged flying capacitor 104 boosts its output to nearly twice the voltage of the MCU supply.

Output capacitor 106 begins completely discharged. With the output of flying capacitor 104 at nearly twice the supply voltage, the charge will transfer from flying capacitor 104 to and output capacitor 106. The cycle will repeat and the flying capacitor 104 will act as a ‘bucket’ to transfer the charge to the output capacitor.

The Schottky (or hot carrier) diodes 103 and 105 prevent reverse leakage current, or the flow of charge back to the charging source, and also create a very low forward voltage drop. With sufficient charge present in the output capacitor 106, the output voltage will remain constant for a given load.

Additionally, the microprocessor is used to drive pins 109 and 120 in order to achieve the boosted voltage across output capacitor 114.

If the green LED is to be in the OFF mode, the MCU can drive pin 109 low while shutting off the PWM drive to pin 110. When the green LED is desired to be in the ON mode, the MCU can drive pin 109 high and hence supply the current necessary to charge flying capacitor 112 when pin 110 is driven low.

Thereafter, the MCU will raise the PWM pin from low to high on one cycle of pulsing on pin 110. The high voltage at the low side of charged capacitor 112 boosts its output to nearly twice the voltage of the MCU supply.

Capacitor 114 begins completely discharged. With the output of flying capacitor 112 at nearly twice the supply voltage, the charge will transfer from flying capacitor 112 to capacitor 114. The cycle repeats and the flying capacitor 112 acts as a ‘bucket’ to transfer the charge to the output capacitor.

The Schottky diodes 111 and 113 prevent the flow of charge back to the charging source. With sufficient charge present in the output capacitor 114, the output voltage will remain constant for a given load.

Additionally, the microprocessor is used to drive pins 116 and 117 in order to achieve the boosted voltage across output capacitor 121.

If the blue LED is to be in the OFF mode, the MCU can drive pin 116 low while shutting off the PWM drive to pin 117. When the blue LED is desired to be in the ON mode, the MCU can drive pin 116 high and thereby supply the current necessary to charge flying capacitor 119 when pin 117 is driven low.

Thereafter, the MCU will raise the PWM pin from low to high on one cycle of pulsing on pin 117. The high voltage at the low side of charged flying capacitor 119 boosts its output to nearly twice the voltage of the MCU supply.

Output capacitor 121 begins completely discharged. With the output of flying capacitor 119 at nearly twice the supply voltage, the charge will transfer from flying capacitor 119 to output capacitor 121. The cycle repeats and the flying capacitor 119 acts as a ‘bucket’ to transfer the charge to the output capacitor.

The Schottky diodes 118 and 120 prevent the flow of charge back to the charging source. With sufficient charge present in the output capacitor 121, the output voltage will remain constant for a given load.

The load present will depend on the particular voltage drop across the LED 107 and may vary by a few tenths of millivolts across manufacturing tolerances. Thus, resistor 108 can be selected to allow a nominal load that is sufficient to light the LED. Typical drive current should be in the range of 10-20 mA but can be lower if the LED does not require maximum intensity output. It is suggested that the value of the resistor be empirically set by letting the charge pump network run at maximum efficiency and adjusting resistor 108 with a potentiometer until the maximum desired LED intensity is reached. The value of the potentiometer can then be replaced with the next closest standard and fixed value resistor, shown in 108. The maximum intensity during the ON state can be reduced to zero by means described below.

It is important to note that given a particular load, a particular set of Schottky diodes, and a particular size for capacitors, there will be an optimal PWM frequency and duty cycle driven to the charge pump that will maximize the output voltage. Under the setup given herein, the optimal frequency lies between 20 kHz and 1 MHZ.

Depending on the source current capabilities of the MCU output pins, the maximum amount of current available at the output capacitor 106 may be limited. The voltage output may drop back to the originating voltage or lower when the output pin is overloaded.

The microprocessor is employed to drive the green LED using the network of 109 thru 115 in a manner identical to the way it used the network of 101 thru 108. Since a green LED between pins 3 and 4 of 107 is to be driven, the voltage drop across the green LED will be different than that in the red LED network. Hence each of the resistors 108, 115, and 122 must be calibrated independently. One will find that the final value of resistor 115 is slightly lower in value than the final value of 108 to compensate for the higher voltage drop of a green LED.

To calibrate and drive the green LED, resistor 115 should have a nominal resistance value. The nominal value should be determined through trial and error; thus, the MCU can be employed to find the optimal driving frequency and duty cycle for a load close to the final load. This is done by having the MCU drive pin 109 high and also by driving a PWM signal at pin 110. With the optimal frequency and duty cycle identified (likely to be between 20 kHz and 1 MHZ and roughly 50%, respectively), resistor 115 can be replaced by a potentiometer. The potentiometer facilitates fast resistance adjustment to find the maximum driving current. The calibration may take several iterations, because every time the load changes, the optimal PWM frequency and duty cycle will change slightly.

Finally, the blue LED network 116 thru 122 is similar to the green LED network 109 thru 115. The same calibration method for the green LED will apply to the blue LED, as well as to the red LED. Resistor 122 will be yet a different value than resistor 115 due to the different voltage drop across the differently colored LED.

Considered together, the full network of 101 thru 122 requires only three logic pins and three PWM pins of the MCU to drive an RGB LED. At the same time, the low-cost method typically requires that the un-boosted power supply of the MCU be only at a low 3.3V.

Those skilled in the art will recognize that the topology of two Schottky diodes 103 and 104 and two capacitors 104 and 106 is a well known method for doubling voltage using a PWM output of a microprocessor. However, the use of this topology for driving an LED array is hitherto unknown. Furthermore, varying the PWM frequency and duty cycle driven to the charge pump to obtain the proper color balance in separate Red, Green, and Blue branches of the circuit allows for a novel cost-effective and space saving method for driving an RGB LED array.

There are two distinct and controllable methods to vary the LED intensity. These methods involve either (1) varying the frequency driven to the charge pump while keeping the duty cycle fixed, or (2) varying the duty cycle driven to the charge pump while keeping the frequency fixed. Varying the frequency is generally works best by reducing the switching frequency, because increasing the frequency will not reduce the output voltage. Reducing the frequency of the PWM signal driven to the charge pump causes the flying capacitor 104 to charge fully, but it also increases the time over which the output capacitor 106 discharges. Reducing the PWM frequency driven to the charge pump will allow the MCU to reduce the output voltage from the optimal voltage level down to nearly the MCU supply voltage. It is preferable to keep the duty cycle at approximately fifty percent (50%) if choosing to fix the duty cycle for optimal output voltage when an optimal PWM frequency is used.

The other method of changing the duty cycle works under roughly the same principle. Assuming that an optimal PWM frequency driven to the charge pump is empirically determined, the duty cycle driven to the charge pump can be varied either by decreasing the duty cycle or increasing it. By decreasing the duty cycle driven to the charge pump, the flying capacitor 104, 112, or 119 will not have a chance to fully charge and will thus “starve” the output capacitor 106, 114, or 121. This results in a reduced steady state output voltage. By increasing the duty cycle driven to the charge pump, the flying capacitor 104, 112, or 119 has ample time to charge but is limited in the amount of time to charge the output capacitor 106, 114, or 121. Hence the output capacitor is also “starved” of the needed current to keep the output voltage constant. The result is also a reduction of output voltage and a reduced perceived brightness in the output LED.

When these methods are applied to each LED in the RGB LED separately, as shown in FIG. 1, the MCU may individually tailor each LED to have a certain drive and thus be able to produce a particular color of the visible spectrum within the range of the RGB LED used.

Because the parameters for the PWM frequency driven to the charge pump and the duty cycle driven to the charge pump may not be in a linear relationship to the perceived brightness, a firmware (internal) lookup table may be created in the MCU for each type of LED to be driven. For example, if the color white is to be displayed on the RGB LED, it will be necessary to have a particular mix of Red, Green, and Blue color, and each color will require a set intensity. Thus, if a variable frequency and fixed duty cycle are used, each color will have a lookup table to drive each charge pump at a certain set frequency. The output of the charge pump will then power each LED with a set current. A similar situation arises when a fixed frequency is used, wherein each LED then has a look-up table for the proper duty cycle to set in the PWM signal used to drive the charge pump. In addition, achieving a given level of dimming for a given color requires yet another unique mix of Red, Green, and Blue colors. Thus, it is useful to add dimming levels to the lookup table, whether the table controls frequency or duty cycle.

Each color of the RGB LED has a different voltage drop, and resistors 108, 115, and 122 may be different. Thus, a certain frequency driven to a green LED may not yield the same perceived intensity if driven to a blue LED. Also, since each color LED is based on a slightly different technology, the intensity differs even when using the same amount of drive current. Hence, a properly-constructed lookup table normalizes and corrects the variability.

Furthermore, one may not need to be limited to requiring a lookup table for each color. With a given topology and circuit devices, a rough relationship between the PWM frequency used to drive the charge pump and the perceived brightness of each LED can be determined. With this information, a rough linear equation can be created from the non-linear relationship and can be employed to drive each LED accordingly. As previously stated, this can also be done by analyzing the effects of changing duty cycle or frequency in relation to the perceived brightness of each LED.

Summarizing the present invention is an innovative method of driving an RGB LED array. Using three separate inexpensive charge pumps instead of an expensive boost regulator is an principal advantage of the present method. Furthermore, varying the PWM frequency driven to the charge pump or varying the duty cycle driven to the charge pump allows adjustment of the resulting drive current that flows through the driven LED. The present invention essentially takes advantage of the limitations in a pulse-width modulated charge pump. The limitation is that modulating a charge pump at an inefficient frequency will lower the current drive capability. However, in this disclosure, the limitation is usefully exploited to reduce the current drive as desired in order to vary the intensity of the LED being driven.

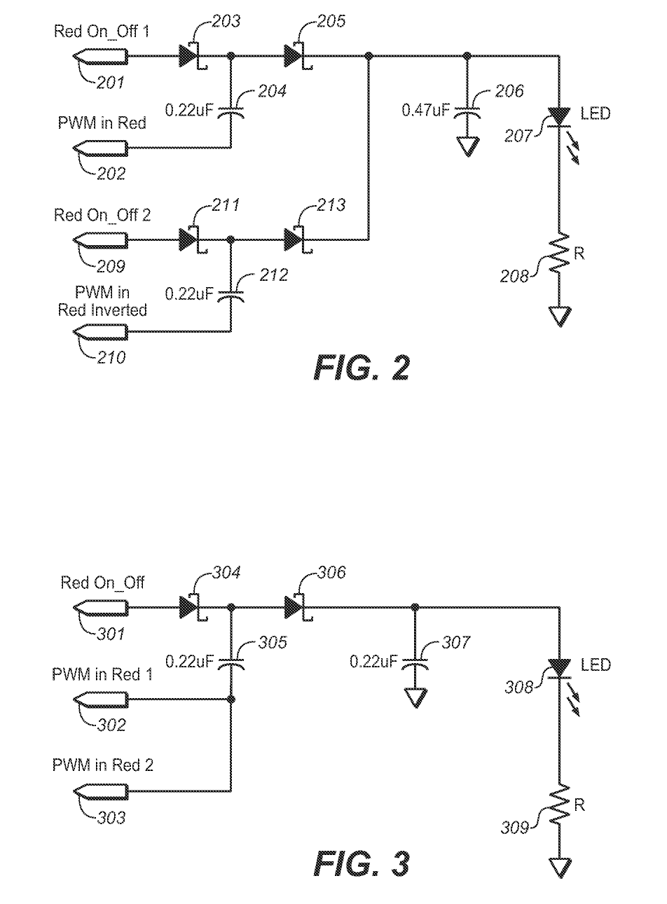

Referring next to FIG. 2 there is shown an alternative driving network and method for driving a single LED. This method can be extended to drive an RGB LED by using three sets of such driving networks. The diagram shows two voltage doublers arranged to sum the total current capabilities in two branches driven by 201, 202, 209 and 210. The structure encompassing 201 through 208 is similar to a single branch in FIG. 1. The additional structure encompassing 209 through 213 adds additional current drive capability to the circuitry.

As in a typical MCU, the output pin may drive from 10 mA to 40 mA. The actual achieved steady-state current output will be approximately 25%-50% of the current drive capability. This is due to the fact that the output pin will not charge the intermediate capacitor 204 at the maximum capacity at all times because current flow decreases as the capacitor voltage nears the supply voltages of the MCU.

The novelty in this embodiment resides in the signal used to drive 210, which is the inverted signal of the signal used to drive pin 202. This dual drive method essentially reduces the output ripple by 50% by not allowing the output capacitor 206 to discharge during the charging phase of the flying capacitor 202. The current drive capability is essentially the same as that in FIG. 3, but the output voltage will be slightly elevated due to the removal of some ripple.

When it is required to turn on LED 207, pin 201 is held high to supply current to charge capacitor 204 through Schottky diode 203. The PWM input at pin 202 is initialized at zero. When capacitor 204 is charged, the MCU drives pin 202 high and thus raises the voltage at the output of the capacitor 204 to twice that of the voltage supplied at pin 201. Thereafter, since diode 203 prevents back flow of current, capacitor 206 is charged using capacitor 204. While the doubled voltage will not be present after the first cycle of charge exchange, capacitor 206 will build enough charge after numerous pulses of the PWM signal driven to pin 202. If a sustainable load is present at the output capacitor 206, then a steady raised voltage will be present. At this steady state voltage, a certain current will flow through the LED 207. The steady state current that flows through LED 207 is determined by resistor 208, the value for which is determined empirically by substitution with a potentiometer to obtain the maximum brightness desired. With the value determined, the potentiometer can then be replaced with a fixed value resistor. After calibration, the brightness obtained with the fixed resistor is the maximum brightness chosen in the calibration. Henceforth, the brightness can be reduced by the inventive method. That is, to vary the frequency and/or the duty cycle to reduce the efficiency of the charge pump.

The second branch encompassing 209 thru 213 adds additional current drive capability as well as a reduction in output ripple. As before, the MCU will supply current to capacitor 212 by driving pin 209 high at the same time that pin 210 drives the other side of capacitor 212 low. Capacitor 212 then charges up to nearly the voltage present at pin 209. Pin 210 initiates at a low state and pulses high. The transition to a high state causes the capacitor 212 to raise its output voltage to nearly twice the charging voltage that was present in pin 209. Diode 211 prevents back flow of current. Output capacitor 206 may be discharged or partially charged or in the process of charging by the first branch. In any case, capacitor 212 will dump some of its charge into the output capacitor 206. Both diode 205 and 213 prevent charge from escaping back into capacitor 204 or 212 when either PWM pin 202 or 210 are low during the low phase of the PWM signal.

In effect, branch 201 through 205 and branch 209 through 213 cooperate to charge output capacitor 206. Due to their complimentary nature, they take turns charging the output capacitor 206 and hence reduce the output ripple. Finally, the steady state voltage at the output drives the LED 207 through resistor 208.

Referring now to FIG. 3, there is shown a simpler method to add additional current drive capability to the output circuit without adding additional parts. In this method, the PWM signal driven to 302 and 303 must be the same signal but driven from two separate output pins of the MCU. In this method, extra current capability is added to drive the flying capacitor to the higher voltage. Using this method, however, will not reduce ripple.

Beginning with a high signal at pin 301 and a low signal at pins 302 and 303, capacitor 305 is charged through diode 304. After charging, both pin 302 and pin 303 start from a low state and are driven to a high state. The voltage present at the output of capacitor 305 is thus raised to nearly twice the initial charge voltage. Diode 304 prevents back flow of current that might occur because voltage at capacitor 305 is higher than the MCU power supply. With capacitor 307 initially discharged, capacitor 305 proceeds to charge capacitor 307 through diode 306. Output capacitor 307 will then reach a steady state voltage after a certain number of pulses on the input PWM pins 302 and 303. The charge output capacitor 307 will then drive LED 308 through resistor 309. Depending on the resistance used at resistor 309, the drive current for the LED 308 will vary.

The method described in FIG. 3 can be extended for use on each of the red, green, and blue LEDs in order to obtain the proper color balance. To properly double the current capacity of each branch, it is preferable that two pins of the MCU drive pin 301.

Instead of using valuable MCU pins to drive a single LED, it may sometimes be more economical to increase the drive current by ganging multiple inverters in parallel. High current inverters are available that allow only one inverter to be used while supply two to three times the current capacity of a typical MCU. Therefore, if further drive current is still needed, high current inverters can be used either singly or in multiples.

Another embodiment of the present invention is to drive negative charge pumps, with a similar diode/capacitor construction. An LED with a forward voltage greater than the system voltage may be driven between a negative charge pump output and the positive rail. For example, in a 3.3V system, a negative charge pump will provide about −3V, which will develop a potential of about 6.3V with the positive supply rail. This is enough to drive a Blue or green LED which cannot otherwise be driven with a 3.3V supply rail alone. This technique is useful for driving common-anode LED arrays which require separate regulation of the low sides (cathodes) of the LEDs since the high sides (anodes) are tied together.

The foregoing disclosure is sufficient to enable those with skill in the relevant art to practice the invention without undue experimentation. The disclosure further provides the best mode of practicing the invention now contemplated by the inventor. It should not be construed as limiting the scope of the invention, which is defined by the appended claims.

What is claimed as invention is:

1. A circuit for controlling color balance in an LED, comprising:
at least one LED;
a charge pump including first and second inputs, two Shottky dioides, a switched capacitor network having a flying capacitor and an output capacitor, and an output node for sending a signal to said at least one LED;
at least one resistor in line with said LED; and
a microprocessor having a first output pin connected to said first input for turning on and off power to said charge pump, and a second output pin connected to said second input for providing a signal and power to said switched capacitor network;
wherein pulsing of said second output pin boosts voltage at said output capacitor and the boosted voltage is maintained by the capacitance at said output node of said charge pump.

2. The circuit of claim 1, wherein said microprocessor maintains sufficient voltage in said circuit by adjusting the frequency and duty cycle of the PWM signal driven to said second input.

3. The circuit of claim 1, wherein the intensity range of said LED is adjusted by tuning the relationship between the PWM frequency driven to said second input, the PWM duty cycle driven to said second input, the values of said flying capacitor and said output capacitor, and the value of said at least one resistor.

4. A circuit for controlling RGB LED color balance, comprising:
an RGB LED array;
first, second, and third charge pumps, each including first and second inputs, two Shottky diodes, a switched capacitor network having a flying capacitor and an output capacitor, and an output node for sending a signal to one of the red, green, or blue LEDs in said RGB LED array;
at least one resistor in line with each of said LEDs; and
a microprocessor having, for each of said first second and third charge pumps, a first output pin connected to said first input for turning on and off power to said charge pump, and a second output pin connected to said second input for providing a signal and power to said switched capacitor network;
wherein pulsing of each of said second output pins boosts voltage at each of said output capacitors and the boosted voltage is maintained by the capacitance at each of said output nodes of each of said first through third charge pumps, and wherein the relative intensities of each of said LEDs in said RGB LED array can be adjusted to obtain proper color balance.

5. The circuit of claim 4, wherein a high resolution PWM is used to drive each of said first through third charge pumps.

6. A circuit for controlling RGB LED color balance, comprising:
an RGB LED array including a red LED, a green LED and a blue LED;
a red LED charge pump for said red LED, said red LED charge pump including an on/off input and a PWM signal input, Shottky diodes, a switched capacitor network having a flying capacitor and an output capacitor, and an output node for sending a signal said red LED;
a green LED charge pump for said green LED, said green LED charge pump including an on/off input and a PWM signal input, two Shottky diodes, a switched capacitor network having a flying capacitor and an output capacitor, and an output node for sending a signal said green LED;
a blue LED charge pump for said blue LED, said blue LED charge pump including an on/off input and a PWM signal input, two Shottky diodes, a switched capacitor network having a flying capacitor and an output capacitor, and an output node for sending a signal said blue LED;
at least one resistor in line with each of said LEDs; and
a microprocessor having a first output pin connected to said on/off input of said red LED charge pump for turning on and off power to said red LED charge pump, a second output pin connected to said PWM signal input of said red LED charge pump for providing a signal and power to said switched capacitor network of said red LED charge pump, a third output pin connected to said on/off input of said green LED charge pump for turning on and off power to said green LED charge pump, a fourth output pin connected to said PWM signal input of said green LED charge pump for providing a signal and power to said switched capacitor network of said green LED charge pump, a fifth output pin connected to said on/off input of said blue LED charge pump for turning on and off power to said blue LED charge pump, and a sixth output pin connected to said PWM signal input of said blue LED charge pump for providing a signal and power to said switched capacitor network of said blue LED charge pump;
wherein pulsing of each of said second, fourth and sixth output pins boosts voltage at each output capacitor of each of said switched capacitor networks and the boosted voltage is maintained by the capacitance at each of said output nodes of each of said charge pumps, and wherein the relative intensities of each of said LEDs in said RGB LED array can be adjusted to obtain the proper color balance.

7. The circuit of claim 6, wherein in operation, if any of said red, green, or blue LED is to be in the OFF mode, said microprocessor drives the respective on/off input pin to said charge pump low while shutting off drive to said PWM signal input, and when any of said red, green, or blue LED is to be in the ON mode, said microprocessor drives the respective on/off pin high and thereby supplies the current necessary to charge said flying capacitor in the respective charge pump when the output pin to a respective PWM signal input is driven low.

8. The circuit of claim 6, wherein said microprocessor will raise said second, fourth, and sixth output pins from low to high on one cycle of PWM pulsing, and wherein the high voltage at the low side of each of said flying capacitors at each respective charge pump boosts its output to nearly twice the voltage of the voltage supplied by said microprocessor.

9. The circuit of claim 6, wherein the value of each of said resistors in line with a respective LED is calibrated according to the voltage drop across the respective LED, and the frequency and duty cycle for PWM signals sent to each of said PWM inputs and to each of said charge pumps is varied by said microprocessor to obtain the proper color balance in separate red, green, and blue branches of said circuit.

10. The circuit of claim 6, wherein to achieve proper color balance in said RGB LED array, said microprocessor varies the frequency driven to each of said charge pumps while keeping duty cycles fixed

11. The circuit of claim 6, wherein to achieve proper color balance in said RBG LED array, said microprocessor varies the duty cycle driven to each of said charge pumps while keeping frequencies fixed.

12. The circuit of claim 6, wherein said microprocessor includes a lookup table employed to normalize and correct variability in color intensity due to variability in voltage drops for said LEDs in said LED array and variability in the values of said resistors.

13. The circuit of claim 6, further including an auxiliary charge pump coupled to said output node of each of said which feeds said output node a PWM signal inverted in relation to the signal in said output node for reducing ripple.
